(19) United States
(12) Patent Application Publication
(10) Pub. No.: US 2022/0069270 A1
(43) Pub. Date: Mar. 3, 2022

(54) BATTERY, METHODS OF MANUFACTURE THEREOF AND ARTICLES COMPRISING THE SAME

(71) Applicant: GM Global Technology Operations LLC, Detroit, MI (US)

(72) Inventors: Thomas A. Yersak, Royal Oak, MI (US); James R. Salvador, East Lansing, MI (US); Fang Hao, Sterling Heights, MI (US); Chansoon Kang, Troy, MI (US)

(21) Appl. No.: 17/011,640

(22) Filed: Sep. 3, 2020

(51) Int. Cl. H01M 2/16; H01M 4/134; H01M 10/0525; H01M 10/0563

(52) U.S. Cl. CPC H01M 2/1666; H01M 4/134; H01M 2004/027; H01M 10/0525; H01M 10/0563; H01M 2/1646

(57) ABSTRACT

A battery comprises a positive current collector that contacts a composite cathode and a negative current collector that supports an anode. The anode is opposedly disposed to the composite cathode. A compliant interlayer and a separator are located between the anode and the composite cathode, where the compliant interlayer comprises a compliant electrolyte. The separator is in a protective relationship with the cathode and prevents the compliant electrolyte from contacting the composite cathode.

### STATEMENT REGARDING FEDERALLY SPONSORED RESEARCH OR SUPPORT

This invention was made with U.S. Government support under Agreement No. DE-EE0008857 awarded by the U.S. Department of Energy. The U.S. Government may have certain rights in this invention.

### BACKGROUND

This disclosure relates to batteries, methods of manufacture thereof and to articles comprising the same. In particular, this disclosure relates to solid state batteries having a cathode-supported solid state electrolyte separator and a compliant lithium-metal interlayer.

All solid state batteries use stack pressures up to 3 MPa (approximately 435 pounds per square inch (psi)) to cycle, otherwise the lithium metal anode loses contact at sufficiently high current densities. State of the art cathode-supported separators are generally porous. The use of a compliant interlayer at the lithium metal interface may reduce cell longevity because it may permeate the porous separator and damage the composite cathode.

It is therefore desirable to have solid state batteries where the liquid electrolyte is segregated from the cathode to prevent damage to the cathode.

### SUMMARY

In one exemplary embodiment, a battery comprises a positive current collector that contacts a composite cathode and a negative current collector that supports an anode. The anode is opposedly disposed to the composite cathode. A compliant interlayer and a separator are located between the anode and the composite cathode, where the compliant interlayer comprises a compliant electrolyte. The separator is in a protective relationship with the cathode and prevents the compliant electrolyte from contacting the composite cathode.

In another embodiment, the compliant electrolyte comprises a liquid electrolyte.

In yet another embodiment, the separator is impermeable to the compliant electrolyte.

In yet another embodiment, the separator comprises a sulfide glass.

In yet another embodiment, the anode comprises lithium metal.

In yet another embodiment, the compliant interlayer contacts the anode.

In yet another embodiment, the separator contacts the positive current collector and where the composite cathode is encapsulated between the separator and the positive current collector.

In yet another embodiment, the separator further comprises a binder and a reinforcement.

In yet another embodiment, the sulfide glass comprises i) one or more glass formers selected from the group consisting of P₂S₅, SiS₂, GeS₂, SnS₂, P₂O₂5, B₂O₃, SiO₂, Al₂O₃, or a combination thereof; ii) one or more glass modifiers selected from the group consisting of Li₂S, Na₂S, Li₂O, Na₂O, or a combination thereof; and iii) one or more dopants selected from the group consisting of LiI, Li₃PO₄, Li₄SiO₄, or a combination thereof.

In yet another embodiment, the binder is a polymer.

In yet another embodiment, the reinforcement is an aramid fiber or a glass fiber.

In yet another embodiment, the liquid electrolyte is an ether-based liquid electrolyte, a polymer or gel electrolyte, a solvent-in-salt electrolyte, a room temperature ionic liquid electrolyte or a combination thereof.

In one embodiment, a method of manufacturing a battery comprises disposing between a composite cathode and an anode a separator and a compliant interlayer that comprises a compliant electrolyte. The separator is in a protective relationship with the cathode and prevents the compliant electrolyte from contacting the composite cathode.

In another embodiment, a positive current collector is disposed on the composite cathode and a negative current collector is disposed on the cathode.

In yet another embodiment, the separator, the composite cathode and the positive current collector are laminated together.

In yet another embodiment, the separator is impermeable.

In yet another embodiment, the separator comprises a sulfide glass.

In yet another embodiment, the sulfide glass comprises i) one or more glass formers selected from the group consisting of P₂S₅, SiS₂, GeS₂, SnS₂, P₂O₅, B₂O₃, SiO₂, Al₂O₃, or a combination thereof; ii) one or more glass modifiers selected from the group consisting of Li₂S, Na₂S, Li₂O, Na₂O, or a combination thereof; and iii) one or more dopants selected from the group consisting of LiI, Li₃PO₄, Li₄SiO₄, or a combination thereof.

In yet another embodiment, the compliant electrolyte is a liquid electrolyte.

In yet another embodiment, the liquid electrolyte is an ether-based liquid electrolyte, a polymer or gel electrolyte, a solvent-in-salt electrolyte, or a combination thereof.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an exemplary schematic depiction of the battery;

FIG. 2 is a depiction of a battery as part of a circuit that has a load;

FIG. 3 is an exemplary schematic depiction of one method of manufacturing the battery; and

FIG. 4 depicts a series of micrographs that were used to determine permeability of the separator.

### DETAILED DESCRIPTION

The following description is merely exemplary in nature and is not intended to limit the present disclosure, its application or uses.

Disclosed herein is a battery that comprises a solid state composite cathode, a cathode-supported impermeable solid state electrolyte (SSE) separator and a compliant ionically conductive interlayer disposed between the cathode-supported impermeable separator and a lithium metal electrode. The cathode-supported impermeable solid state electrolyte separator is impermeable to liquid, polymer or gel electrolytes. The use of an impermeable, cathode-supported separator allows for the application of liquid/gel/polymer electrolyte only where it is needed in the battery, such as, for example at the lithium metal interface and keeps it away from the composite cathode, where it can deplete lithium and reduce battery life. The resulting solid state lithium metal battery has an improved energy density, faster charge rate and uses a lower stack pressure over other currently commercially available solid state electrolyte batteries. This approach increases the energy density and rate capability of solid state lithium ion and lithium metal batteries.

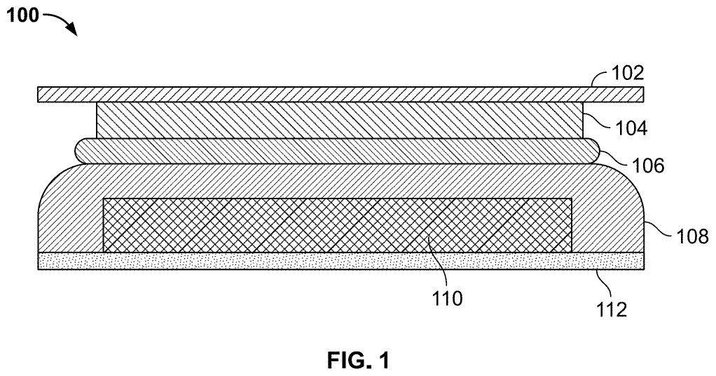

FIG. 1 depicts an exemplary embodiment of the battery 100 (also known as an all solid state electrochemical cell) that comprises a negative current collector 102 disposed at or near a lithium metal anode 104 (hereinafter lithium anode 104). In an embodiment, the negative current collector 102 is in direct contact with the lithium metal anode 104. Disposed opposite the negative current collector 102 is a positive current collector 112. The positive current collector 112 is disposed at or near a hot pressed, all solid state composite cathode 110 (hereinafter composite cathode 110). In an embodiment, the positive current collector 112 is in direct contact with the composite cathode 110.

Disposed between the composite cathode 110 and the lithium anode 104 is a compliant interlayer 106 and a hot-pressed cathode supported sulfide solid state electrolyte separator 108 (hereinafter the separator 108) that are in direct contact with one another. The separator 108 is in a protective relationship with a hot pressed, all solid state composite cathode 110 (hereinafter composite cathode 110). In an embodiment, the separator 108 surrounds all surfaces of the composite cathode 110 except for the surface that contacts the positive current collector 112.

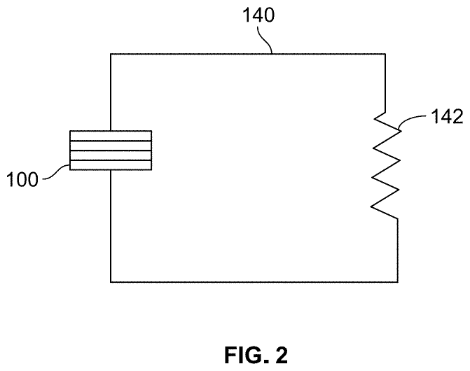

FIG. 2 depicts the battery 100 in communication with an external circuit 140 comprising a load 142. The negative current collector 102 and the positive current collector 112 respectively collect and move free electrons to and from an external circuit 140. For example, an interruptible external circuit 140 and a load device 142 may connect the lithium metal anode 104 (through the negative current collector 102) and the composite cathode 110 (through the positive current collector 112).

The battery 100 can generate an electric current during discharge by way of reversible electrochemical reactions that occur when the external circuit 140 is closed (to connect the lithium metal anode 104 and the composite cathode 110). With reference now to the FIGS. 1 and 2, the chemical potential difference between the lithium metal anode 104 and the composite cathode 110 drives electrons produced by the oxidation of lithium at the lithium metal anode through the external circuit 140 towards the composite cathode 110. Ions, which are also produced at the lithium metal anode 104 are concurrently transferred through the solid state electrolyte in the compliant interlayer 106 and the separator 108 towards the composite cathode 110. The electrons flow through the external circuit and the ions migrate across the solid state electrolyte (in the compliant interlayer 106 and the separator 108 towards the composite cathode 110) to the composite cathode 110 where they may be plated, reacted, or intercalated. The electric current passing through the external circuit can be harnessed and directed through the load device until the lithium in the lithium metal anode 104 is depleted and the capacity of the battery 100 is diminished.

The lithium metal anode 104 may be formed from a lithium host material that is capable of functioning as a negative terminal of the battery 100. In one embodiment, the lithium metal anode 104 may contain only lithium metal. In another embodiment, the lithium metal anode 104 may contain negative solid state electroactive particles.

For example, in certain variations, the lithium metal anode 104 may be defined by a plurality of negative solid state electroactive particles. The negative electroactive materials may include particles of graphite, graphene, carbon nanotubes (CNTs), lithium titanium oxide (Li₄Ti₃O₁₂), sodium titanium oxide (Na₄Ti₅O₁₂), one or more metal oxides, such as, for example, V₂O₅ and one or more metal sulfides, such as, for example, FeS. In an exemplary embodiment, the lithium metal anode 104 contains only lithium metal.

In an exemplary embodiment, the lithium metal anode 104 may comprise only lithium metal without the negative electroactive particles. The lithium metal anode 104 may have a thickness of 1 to 100 micrometers, preferably 10 to 80 micrometers, and more preferably 20 to 60 micrometers.

The compliant interlayer 106 is preferably ionically conductive and is disposed between the separator 108 and the lithium metal anode 104. The compliant interlayer 106 facilitates a superior-contact with the lithium metal anode 104 which permits lower interface resistance and faster charge rates at a reduced stack pressure when compared with other commercially available batteries that do not have the compliant interlayer 106. The compliant interlayer 106 may comprise a solid state electrolyte that is compliant (i.e., can be easily deformed, preferably by hand without the use of mechanical tooling, though mechanical tooling may be used if so desired) and can take any shape taken by the battery. The compliant interlayer 106 may optionally comprise a porous support (e.g., a woven support, non-woven support, a porous polymeric support, or the like, or a combination thereof).

In an embodiment, the compliant interlayer 106 may be an ether-based liquid electrolyte, a polymer electrolyte, a solvent-in-salt electrolyte, or a combination thereof.

Ether-based liquid electrolytes include lithium salts that are dissolved in cyclic and noncyclic ethers. Lithium salts which can be dissolved in the ether to form the nonaqueous liquid electrolyte solution include LiClO₄, LiAlCl₄, LiI, LiBr, LiSCN, LiBF₄, LiB(C₅H₅)₄, LiAsF₆, LiCF₃SO₃, LiN(FSO₂)₂, LiN(CF₃SO₂)₂, Li AsF₆, LiPF₆, or mixtures thereof. The ether-based solvents include cyclic ethers, such as, for example, 1,3-dioxolane (DOL), tetrahydrofuran, 2-methyltetrahydrofuran; and chain structure ethers, such as, for example, 1,2-dimethoxyethane (DME), 1,2-diethoxyethane, ethoxymethoxyethane, tetraethylene glycol dimethyl ether (TEGDME), polyethylene glycol dimethyl ether (PEGDME), or mixtures thereof.

Other solvents that may be used in the ether-based liquid electrolyte may include acetonitrile, amides, benzonitrile, butyrolactone, cyclic ether, dibutyl carbonate, diethyl carbonate, diethylether, dimethoxyethane, dimethyl carbonate, dimethylformamide, dimethylsulfone, dioxane, dioxolane (DOL), ethyl formate, ethylene carbonate (EC), ethylmethyl carbonate (EMC), lactone, linear ether, methyl formate, methyl propionate, methyltetrahydrofuran, nitrile, nitrobenzene, nitromethane, n-propylene carbonate, sulfolane, sulfone, tetrahydrofuran, tetraniethylene sulfone thiophene, ethylene glycol, diethylene glycol, triethylene glycol, polyethylene glycols, carbonic acid ester, γ-butyrolactone, nitrile, tricyanohexane, or a combination thereof

In an exemplary embodiment, the electrolyte comprises 1 M LiPF₆ in 1:1 (v/v) of EC:EMC or 0.6 M LiTFSI (lithium bis(trifluoromethanesulfonyl)imide)+0.4M LiNO₃ (lithium nitrate) in 1:1 (v/v) DME:DOL.

The compliant layer 106 may also comprise a liquid electrolyte component and a polymeric component (e.g., a polymer protection layer) that are called a “polymer electrolyte”, Polymer electrolytes are capable of maintaining surface contact with the negative electrode as the surface of the negative electrode becomes rough due to a variety of factors such as, for example, the growth of dendrites, irregular deposition of lithium during charging, and so on. This phenomena is often alluded to as the “growth of dendrites” but it includes a wide variety of irregular morphologies observed on the surface of the negative electrode. The liquid electrolyte component and the polymeric component may be distinct layers, or they may be blended. When the components are present as distinct layers, the liquid electrolyte may be disposed adjacent to the negative electrode and the polymeric component, which may include one or more layers, which may be disposed between the liquid electrolyte and the negative electrode. When the components are blended, the resultant electrolyte system may have a blended gel or composite structure.

The liquid electrolyte component can include liquid electrolytes detailed above and below. in the interest of brevity additional description of the electrolyte will not be pursued here. In an embodiment, the liquid electrolyte component contains the lithium salt. The lithium salts listed above can be included in these polymer electrolytes.

The polymer component may include solid state polymeric electrolytes such as polyethylene oxide (PEO), polymethylmethacrylate (PMMA), polyacrylonitrile (PAN), polyvinylidene fluoride (PVDF) and gel electrolytes (i.e., polymers plasticized with solvent) by way of non-limiting example.

Polymer electrolytes may also include intrinsically conducting polymers such as for example, polyaniline in both neutralized and unneutralized forms, polypyrrole, polythiophene, polyacetylene, polycarbazoles, polyindoles, polyazepines, poly(fluorene)s, polyphenylenes, polypyrenes, polyazulenes, polynaphthalenes, poly(p-phenylene vinylene), or a combination thereof. Polymer electrolytes may be used in the presence of solvents. Solvents used in electrolytes of this type are listed above.

In another embodiment, the polymer electrolyte can be complexed with a Li salt. In these polymer electrolyte there is no solvent to plasticize the polymer so the polymer may he considered dry. The polar groups in the polymer (e.g., —O—, —S—, and the like) are effective building blocks for dissolving lithium salts. For example, in polyethylene oxide, the lone pair of oxygens on the polyethylene oxide segment is coordinated to the lithium ion by Coulombic interaction, causing the anion and cation of the lithium salt to dissociate. in the process, the polyethylene oxide acts as solvent, and the lithium salt dissolves into the polyethylene oxide matrix. In addition to the oxygen atom (—O—) on the polyethylene oxide chain, other atoms such as the nitrogen in the imide (—NH—) and the sulfur in the thiol (—S—) also play a similar role. Under the electric field, the migration movement of Li+ cations are from one coordination point to another along the polymer segment or jump from one segment to another.

The solvent-in-salt electrolyte may include one or more salts bound to a solvent. The electrolyte may include one or more salts having a concentration greater than 1M (molar), preferably greater than 3M, and more preferably greater than 4M. The lithium salts and solvents listed above may also be used in the solvent-in-salt electrolyte.

In an embodiment, the electrolyte includes a combination of room temperature ionic liquids and lithium salts. The room temperature ionic liquids that are used to dissolve lithium salts.

Lithium salts listed above may be dissolved in the room temperature ionic salts. The room temperature ionic salts include organic cations and anions. Organic cations may include 1-(3-cyanopropyl)-3-methylimidazolium, 1,2-dimethyl-3-propylimidazolium, 1,3-bis(3-cyanopropyl)imidazolium, 1,3-diethoxyimidazolium, 1-butyl-1-methylpiperidinium, 1-butyl-2,3-dimethylimidazolium, 1-butyl-3-methylpyrolidinium, 1-butyl-4-methylpyridinium, 1-butylpyridinium, 1-decyl-3-methylimidazolium, 1-ethyl-3-methylimidazolium, 3-methyl-1-propylpyridinium, or a combination thereof.

The anion may include bis(trifluoromethanesulfonate)imide, tris(trifluoromethanesulfonate)methide, dicyanamide, tetrafluoroborate, hexafluorophosphate, trifluoromethanesulfonate, bis(pentafluoroethanesulfonate)imide, thiocyanate, trifluoro(trifluoromethyl)borate, or a combination thereof.

Solvents may also be used in these room temperature ionic liquid based electrolytes and these solvents are included in the list above.

In one exemplary embodiment, the one or more ionic salts may include lithium bis(fluorosulfonyl) imide (LiFSI) and the solvent may be dimethoxyethane. A molar ratio of the one or more salts to the dimethoxyethane may be greater than or equal to about 1 to less than or equal to about 1.5. The electrolyte system may be substantially free of unbound dimethoxyethane and unbound bis(fluorosulfonyl)imide (FSI).

In another embodiment, the electrolyte may include 1M LiFSI in n-propyl-n-methylpyrrolidinium bis(fluorosulfonyl)imide.

The foregoing electrolytes for use in the compliant layer 106 may include one or more electrolyte additives selected from the group consisting of: 3,3,3-trifluoropropylmethyldimethoxysilane, (3,3,3-trifluoropropyl) trimethoxysilane, 1H, 1H, 2H, 2H-perfluorooctylmethyldimethoxysilane, 1H, 1H, 2H, 2H-perfluorooctyltrimethoxysilane, 1H, 1H, 2H, 2H-perfluorooctyldimethylchlorosilane, 1H, 1H, 2H, 2H-perfluorooctylmethyldichlorosilane, (1H, 1H, 2H, 2H-n-hexyl)methyldichlorosilane, 1H, 1H, 2H, 2H, 2H-perfluorooctyltrichlorosilane and combinations thereof.

The compliant interlayer 106 may optionally comprise a porous support. The porous support may comprise a non-woven film, a woven film, porous polymeric film or foam, or a combination thereof. In an embodiment, the porous separator may include a microporous polymeric separator that comprises a polymer. A suitable polymer is a polyolefin. The polyolefin may be a homopolymer (derived from a single monomer component) or a heteropolymer (derived from more than one monomer component), which may be either linear or branched. When a heteropolymer is derived from two monomer constituents, the polyolefin may take any copolymer chain arrangement including those of a block copolymer or a random copolymer. Likewise, a polyolefin which is a heteropolymer derived from more than two monomeric constituents may also be a block copolymer or a random copolymer. In some embodiments, the polyolefin may be polyethylene (PE), polypropylene (PP) or a blend of PE and PP, or a multilayer structured porous film of PE and/or PP. Commercially available microporous polymer membranes polyolefin include CELGARD® 2500 (a single-polypropylene separator) and CELGARD® is a 2320 (a three-layered polypropylene/polyethylene/polypropylene separator) of Celgard LLC.

In an embodiment, the porous separator may be mixed with a ceramic material or its surface coated with a ceramic material. A ceramic coating may include, for example, alumina, silica, titania, zirconia, ceria, or combinations thereof.

The compliant interlayer 106 has a thickness of 1 to 20 micrometers, preferably 3 to 15 micrometers.

The separator 108 functions to prevent the electrolyte in the compliant interlayer 106 from contacting the cathode and is therefore made impermeable. This impermeability prevents dissolution of any passivating materials formed in the solid state electrolyte in the cathode composite 110. The separator 108 also contacts the positive current collector in such a manner as to prevent liquid electrolyte from seeping through to contact the composite cathode 110. Without being limited to theory, it is believed that composite cathode materials that contain sulfide solid state electrolytes and other cathode materials such as, for example, NCM (which comprises lithium, nickel, cobalt and manganese) typically display anodic (oxidative) thermodynamic stability of less than 3 V (volts). The use of NCM in the composite cathode (for lithium batteries) renders the sulfide based solid state electrolyte kinetically stable a) because of the formation of a passivating coating on NCM such as, for example, LiNbO₃, or alternatively b) because the solid state electrolyte decomposes to form a passivating species such as sulfur. The impermeability of the separator 108 also prevents oxidation of the liquid electrolyte. Sulfur remains in place at the NCM/solid state electrolyte interface (thereby protecting the solid stage electrolyte) so long as the composite cathode stays dry. If solvents from the compliant layer 106 reach the solid state electrolyte in the composite cathode 110, the sulfur (which acts as the passivating species) in the solid state electrolyte will be removed by dissolution. Sulfur for example, is highly soluble in ether solvents. This results in degradation of the cathode composite, which results in a reduced life for the battery. Using a separator 108 that is impermeable therefore facilitates retention of passivating species formed in the composite cathode 110, which, in turn extends battery life.

In order to render the separator 108 impermeable it is manufactured from a hot pressed, cathode-supported sulfide solid state electrolyte. The sulfide solid state electrolyte (hereinafter sulfide SSE) is detailed in U.S. Pat. No. 10,680,281 B2, the entire contents of which are hereby incorporated by reference. The sulfide solid state electrolyte may contain a second solid state electrolyte phase (LLZO or LATP). This will be discussed in detail later. The sulfide solid state electrolyte may also be reinforced with non-conducting fibers such as glass or Kevlar fibers.

With reference now once again to the FIG. 1, it may be seen that the separator 108 is disposed between the compliant interlayer 106 and the composite cathode 110. The composite cathode 110 is completely surrounded by the separator 108 on one side and by the positive current collector 112. Put another way, the composite cathode 110 is completely encapsulated by a combination of the separator 108 and the positive current collector 112 as a result of which there is no possible contact between the composite cathode 110 and electrolyte from other parts of the battery.

The separator 108 is made impermeable by consolidating sulfide glasses so as to compress all voids, pores and channels that normally are present in the sulfide glasses as green bodies. This compression reduces pathways by which electrolyte from other parts of the battery (such as the compliant interlayer 106) can travel or diffuse through to the composite cathode 110.

The sulfide glass is an amorphous or partially crystalline lithium-containing and ionically conducting sulfide or oxysulfide glass that is generally prepared from a layer of molten glass or of glass powder. The sulfide and oxysulfide glasses are electrically insulating. The resulting glass separator is formed to lie face-to-face against the composite cathode and provides for good transport of lithium ions between the electrodes while at the same time preventing contact between the composite cathode and electrolyte from other parts of the battery.

Sulfide and oxy-sulfide glasses may be formed by combining three classes of materials: i) one or more glass formers, including, for example, P₂S₅, SiS₂, GeS₂, SnS₂, P₂O₅, B₂O₃, SiO₂, Al₂O₅; ii) one or more glass modifiers, including, for example, Li₂S, Na₂S, Li₂O, Na₂O, and; iii) one or more dopants, for improving the ionic conductivity as well as improving glass formability and/or stability, including, for example, LiI, Li₃PO₄, Li₄SiO₄.

For a sulfide glass both the glass former and the glass modifier will contain sulfur (e.g. Li₂—P₂S₂5). An oxy-sulfide glass may combine an oxide-forming system with a sulfide co-former (for example, and without limitation Li₂O—P₂O₅—P₂S₅) or a sulfide-forming system with an oxide co-former (for example, and without limitation Li₂S—P₂S₅—P₂O₅).

In the following description, at least one component must contain sulfur to support the intended electrolyte activity in the separator 108. Particularly, at least one of the glass formers must contain sulfur to be a sulfide or oxy-sulfide glass but the glass modifier, as noted in the above illustrative example may contain either sulfur or oxygen (in the above non-limiting examples, Li₂S, Li₂O).

These constituent precursors react to form a unique composition that enables the formation of mobile alkali metal cations. For convenience, any compositions detailed in subsequent sections will be described in terms of the atomic proportions of their constituents (for example, 70Li₂S-30P₂S₅). These constituents, when processed, will however form a glass whose empirical composition is Li₇P₃S₁₁ which possesses a structure with mobile lithium ions and anchored phosphorus sulfide tetrahedral anion structural units (PS₄³⁻). Thiophosphates such as, for example, (P₂S₂)⁴⁻ and (P₂S₇)⁻⁴ may also be present in the glass.

The resulting sulfur-containing glass compositions achievable with suitable combinations of these constituents include, without limitation, lithium phosphorous (oxy)sulfide, lithium boron (oxy)sulfide, lithium boron phosphorous oxy-sulfide, lithium silicon (oxy)sulfide, lithium germanium (oxy)sulfide, lithium arsenic (oxy)sulfide, lithium selenium (oxy)sulfide, and lithium aluminum (oxy)sulfide, individually or in combination. The term (oxy)sulfide represents that both an oxygen-free sulfide composition or an oxygen-containing oxy-sulfide may be prepared.

An example of a suitable composition is xLi₂S.(100−x)P₂S₅ where x has a value in an amount of 50 to 90. The composition is formed by preparing a melt of dilithium sulfide and phosphorus pentasulfide at a temperature of about 700° C. The glass former and glass modifier interact to form a glassy composition containing mobile lithium ions.

In an embodiment, a second solid state electrolyte phase that comprises lithium lanthanum zirconate (LLZO), lithium phosphorus oxynitride (LiPON), lithium aluminate titanate phosphate (LATP), or the like, may be added to the sulfide glass prior to melting and forming the molten glass into the separator 108.

An initial lithium-containing sulfide glass composition is in the form of small particles (a powder) having amorphous glassy microstructures. The particles are applied to a quartz substrate layer (or a like material resistant to moderate temperatures of less than about 350° C. and non-reactive with the glass particles) in a thin layer of generally uniform thickness and over an area predetermined for finished formation of the glass separator layer. The amorphous glass particles are then heated on, and consolidated against, the substrate to form a fully integral consolidated glass layer, 10 micrometers to 100 micrometers thick, still having a non-crystalline microstructure. The supported thin glass layer is then annealed to reduce any localized stresses induced in the consolidated microstructure and, if desired, to introduce small isolated crystal phases in the non-crystalline matrix.

The glass layer is carefully removed from the substrate layer and processed as necessary into individual lithium-conducting separator layers for assembly into the battery. Generally, the as-fabricated glass layer thickness will be pre-determined to be suitable for its intended battery use. But because it is intended that the width of the substrate will be greater than the dimension used in a battery electrolyte, and that, preferably, the fabrication process will be continuous, the fabricated thin glass layer sheet may need to be cut, sliced or otherwise apportioned into suitably-sized electrolyte portions.

In a second embodiment, a melt of the interacted constituents is applied to a pre-heated, smooth flat surface of a smooth substrate. The substrate is selected to both be non-reactive by the melt and wettable by the melt so that the melt may freely spread across the substrate surface. A suitable substrate is quartz. The surface area of the substrate and the quantity of applied melt cooperate to form a molten layer of predetermined thickness of between 10 and 100 micrometers and corresponding to the intended thickness of the conductor/separator. The molten layer is then quickly cooled at a rate sufficient to render an amorphous solid as a thin glassy film or layer.

Following an annealing treatment to remove residual stresses and, optionally, partially crystallize the layer, the layer may be removed from its supporting substrate. Again, it is anticipated that the as-fabricated layer will be cut or otherwise sectioned into appropriately-sized portions suited for application as a separator in the battery.

In another aspect, this melt-derived glass layer may be pulverized to form the glassy powder precursor for the powder-based process described in the first embodiment. Such pulverization may be practiced after the melt has been solidified or after the solidified melt has been annealed.

In order to render the separator 108 impermeable, the melt is generally hot pressed at a temperature of 100 to 350° C., preferably 150 to 240° C. at a pressure of 1 to 100 MPa. The hot pressing is conducted for a time period of 1 to 45 minutes. The hot pressing is generally effective to reduce porosity in the sulfide glass separator to less than 7 volume percent, preferably less than 5 volume percent, and more preferably less than 3 volume percent.

In another embodiment, the sulfide glass may be provided with reinforcement that provides support for the separator and prevents it from cracking or shrinking at elevated temperatures. It is desirable for the reinforcement to not react with the electrolyte. The reinforcement is typically provided by fibrous materials of polyaramid (e.g., KEVLAR® or VECRUS®) or glass. The reinforcement may be applied on either side of the separator 108 or alternatively, may be placed in the glass powder before it is hot pressed. The reinforcement may also be applied in the form of woven or non-woven chopped fiber. While the reinforcement is generally electrically insulating, electrically conductive fibers such as carbon fibers, carbon nanotubes, and the like, may also be used.

In one embodiment, the sulfide glass powder may be mixed with an optional electrically conductive material and at least one polymeric binder material to structurally fortify the separator 108. For example, the active materials and optional conductive materials may be slurry cast with such binders, such as, for example, polyvinylidene difluoride (PVdF), ethylene propylene diene monomer (EPDM) rubber, carboxymethoxyl cellulose (CMC), a nitrile butadiene rubber (NBR), lithium polyacrylate (LiPAA), lithium alginate, or a combination thereof. Electrically conductive materials may include graphite, carbon-based materials, powdered nickel, metal particles, or a conductive polymer. Carbon-based materials may include by way of non-limiting example particles of KELTJEN™ black, electrically-conductive carbon black, DENKA™ black electrically-conductive acetylene black, carbon nanotubes (e.g., single wall carbon nanotubes, double wall carbon nanotubes, multiwall carbon nanotubes), acetylene black, carbon black, or the like.

The separator 108 may have a thickness of 10 to 100 micrometers, preferably 20 to 80 micrometers, and more preferably 30 to 70 micrometers.

The composite cathode 110 is manufactured from a composition that comprises 40 to 80 wt % of at least one or more of lithium nickel cobalt aluminum oxide powder (e.g., LiNi_{w}CoₓMn_{y}Al_{z}O₂ where w is 5 to 8, x is 1 to, y is 1 to 2 and z is 0 to 1, LiNi_{0.5}Mn_{0.5}O₂ (LNMO), LiFePO₄, S, Li₂S, or a combination thereof; 20 to 60 wt % of the sulfide solid state electrolyte; up to 5 wt % of an electrically conducting additive and up to 10 wt % of a binder. In an embodiment, the lithium nickel cobalt aluminum oxide powder is commercially available as NMC 532, NMC 622, NMC 811, NCMA.

The sulfide solid state electrolyte, the electrically conducting additive and the binder are detailed above in the section that describes the separator 108.

The lithium nickel cobalt aluminum oxide powder, the electrically conducting additive, the sulfide solid state electrolyte and the binder are mixed together and then subjected to an elevated temperature and pressure to produce the composite cathode. The processing temperature is 160 to 200° C. and the processing pressure is 1 to 300 MPa. The composite cathode 110 displays an ability to deliver an areal capacity of 2 to 10 mAh/cm² and has a thickness of 100 to 500 micrometers.

The negative current collector 102 comprises a copper film that has a thickness of 8 to 20 micrometer, while the positive current collector 112 comprises an aluminum film that has a thickness of 8 to 20 micrometers.

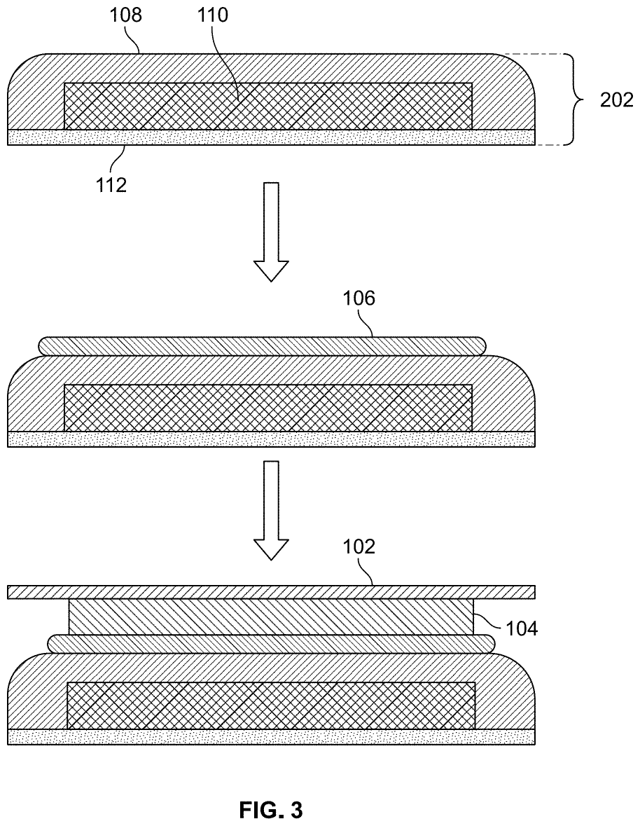

FIG. 3 depicts one method of manufacturing the battery 100. In an embodiment, the ingredients for the separator 108 are mixed together and hot pressed at the desired temperature and pressure to produce the separator 108. In a similar manner, the ingredients for the composite cathode 110 are mixed together and hot pressed to form the composite cathode 110. The separator 108, the composite cathode 110 and the positive current collector 112 are then hot pressed together to form a laminate 202. The edges of the laminate may be sealed if the adequate densification and adhesion between the separator and the positive current collector 112 cannot be achieved.

The compliant interlayer 106 is then disposed on the laminate 202 and contacts the separator 108. The lithium metal anode 104 and the negative current collector 102 are then disposed on the compliant interlayer 106 with the lithium metal anode 104 contacting the compliant interlayer 106.

The battery 100 disclosed herein is advantageous in that the impermeable nature of the sulfide solid state electrolyte prevents diffusion of the liquid electrolyte from the compliant interlayer to the composite cathode that can cause dissolution of any passivating layers or materials (such as sulfur) and or oxidation of the liquid electrolyte. The batteries using the compliant interlayer can be cycled or operated using a stack pressure of less than or equal to 1 MPa. Because of intimate contact between the compliant interlayer and the lithium anode as well as between the compliant interlayer and the separator, the battery can be charged at a much greater rate than similar batteries that do not have the compliant interlayer.

The battery along with the different layers is exemplified by the following non-limiting example.

### EXAMPLE

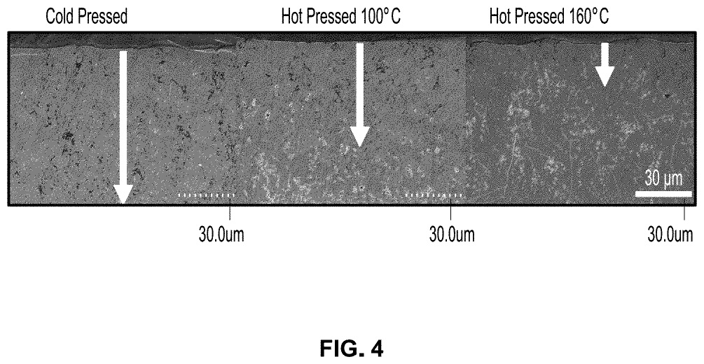

This example demonstrates the impermeable nature of the separator when hot pressed at the appropriate temperatures. The experiment as well as the results of the experiment are shown in the FIG. 4. FIG. 4 shows 3 samples of the sulfide solid state electrolyte. The sulfide solid state electrolyte is β-Li₃S₄. The sample thickness was approximately 30 micrometers.

One sample was cold pressed, while the second sample was hot pressed at a temperature of 100° C. The third sample was hot pressed at a temperature of 160° C. The pressure used for the hot pressing was 100 to 200 MPa kg/cm². The hot pressing was conducted for 10 to 30 minutes.

Epoxy resin was infiltrated into the pores of the sulfide solid state electrolyte for 24 hours (for each of the samples) before being cured on a hot plate. For the cold pressed sample, the cold pressed sulfide solid state electrolyte separators are permeable because the epoxy is detected throughout the thickness of the sulfide solid state electrolyte (as seen by the arrow traversing the entire thickness of the sulfide solid state electrolyte).

The sample that was hot pressed to 100° C. has the epoxy diffusing through more than 50% of the thickness of the sulfide solid state electrolyte (as seen by the arrow traversing at least 50% of the total sample thickness). The sample that was hot pressed to 160° C. has the epoxy diffusing through less than 33% of the thickness of the sulfide solid state electrolyte. After 24 hours on the hot plate, the epoxy permeated the entire thickness of the cold pressed pellet, but only permeated less than about 20 micrometers (66% of the sample thickness) of the sample hot pressed to 160° C. The inability of the epoxy to diffuse through the thickness of the sample hot pressed to 160° C. shows that the solid state electrolyte can be impermeable to electrolytes from the complaint interlayer. This would increase the lifetime of the battery and result in a more rapid rate of charging the battery. From this example it may be seen that a sample thickness of greater than or equal to about 25 micrometers, preferably greater than or equal to about 30 micrometers, and more preferably greater than or equal to about 35 micrometers is effective to prevent liquid electrolyte from contacting the composite cathode and preventing the destruction of any passivating layers/materials formed in the solid state electrolyte.

The battery disclosed herein may be used in a variety of articles such as, for example, an automobile, storage of energy in homes and offices, aircraft, and the like.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A battery comprising:
a positive current collector that contacts a composite cathode;
a negative current collector that supports an anode; where the anode is opposedly disposed to the composite cathode;
a compliant interlayer that comprises a compliant electrolyte; and
a separator; wherein the compliant interlayer and the separator are disposed between the composite cathode and the anode; where the separator is in a protective relationship with the cathode and prevents the compliant electrolyte from the compliant interlayer from contacting the composite cathode.

2. The battery of claim 1, where the compliant electrolyte comprises a liquid electrolyte.

3. The battery of claim 1, where the separator is impermeable to the compliant electrolyte.

4. The battery of claim 1, where the separator comprises a sulfide glass.

5. The battery of claim 1, where the anode comprises lithium metal.

6. The battery of claim 1, where the compliant interlayer contacts the anode.

7. The battery of claim 1, where the separator contacts the positive current collector and where the composite cathode is encapsulated between the separator and the positive current collector.

8. The battery of claim 4, where the separator further comprises a binder and a reinforcement.

9. The battery of claim 4, where the sulfide glass comprises i) one or more glass formers selected from the group consisting of P₂S₅, SiS₂, GeS₂, SnS₂, P₂O₅, B₂O₃, SiO₂, Al₂O₃, or a combination thereof; ii) one or more glass modifiers selected from the group consisting of Li₂S, Na₂S, Li₂O, Na₂O, or a combination thereof; and iii) one or more dopants selected from the group consisting of LiI, Li₃PO₄, Li₄SiO₄, or a combination thereof.

10. The battery of claim 8, where the binder is a polymer.

11. The battery of claim 8, where the reinforcement is an aramid fiber or a glass fiber.

12. The battery of claim 2, where the liquid electrolyte is an ether-based liquid electrolyte, a polymer or gel electrolyte, a solvent-in-salt electrolyte, a room temperature ionic liquid electrolyte or a combination thereof.

13. A method comprising:
disposing between a composite cathode and an anode a compliant interlayer and a separator; where the separator is in a protective relationship with the cathode and prevents the compliant electrolyte from contacting the composite cathode and where the compliant interlayer comprises a compliant electrolyte.

14. The method of claim 13, further comprising disposing a positive current collector on the composite cathode and disposing a negative current collector on the cathode.

15. The method of claim 14, wherein the separator, the composite cathode and the positive current collector are laminated together.

16. The method of claim 13, where the separator is impermeable.

17. The method of claim 13, where the separator comprises a sulfide glass.

18. The method of claim 17, where the sulfide glass comprises i) one or more glass formers selected from the group consisting of P₂S₅, SiS₂, GeS₂, SnS₂, P₂O₅, B₂O₃, SiO₂, Al₂O₃, or a combination thereof; ii) one or more glass modifiers selected from the group consisting of Li₂S, Na₂S, Li₂O, Na₂O, or a combination thereof; and iii) one or more dopants selected from the group consisting of LiI, Li₃PO₄, Li₄SiO₄, or a combination thereof.

19. The method of claim 13, where the compliant electrolyte is a liquid electrolyte.

20. The method of claim 19, where the liquid electrolyte is an ether-based liquid electrolyte, a polymer or gel electrolyte, a solvent-in-salt electrolyte, or a combination thereof.
